(19) United States
(12) Patent Application Publication
(10) Pub. No.: US 2005/0065034 A1
(43) Pub. Date: Mar. 24, 2005

(54) Micro-granular composition with a combined fertilizing and phyto-protective action

(76) Inventors: Sergio Miele, Pisa (IT); Enrica Bargiacchi, Livorno (IT); Luigi Capuzzi, Novara (IT); Edoardo Russo, Piacenza (IT)

Correspondence Address: HEDMAN & COSTIGAN P.C., 1185 AVENUE OF THE AMERICAS, NEW YORK, NY, 10036, US

(21) Appl. No.: 10/496,474

(22) PCT Filed: Nov. 28, 2002
(86) PCT No.: PCT/EP02/13554

(30) Foreign Application Priority Data
Nov. 29, 2001 (IT) MI2001A002509

(51) Int. Cl. A01N 25/00; A01N 25/12

(52) U.S. Cl. 504/367; 71/64.03

(57) ABSTRACT

The present invention relates to a micro-granular composition with a combined fertilizing and phyto-protective activity wherein the diameter of the granules ranges from 0.1 to 2 mm and in which there is a combination of fertilizers and phyto-protective agents, suitably co-formulated thanks to the presence of co-adjuvants capable of maximizing the agronomic efficacy and/or efficiency of the above composition. The composition is suitable for localization at the moment of sowing and transplanting of crops, and in applications close to the seed, the seedling and the plant.

The present invention relates to a micro-granular composition with a combined fertilizing and phyto-protective action.

In particular, the present invention relates to a formulation comprising fertilizers and pesticides, prepared in the form of micro-granules, suitable for localized application to crops.

According to a consolidated practice, the application of fertilizers to cultivated land and phyto-protective treatments are not only carried out with distinct products and types of treatments, but also in different times.

For example, the land is treated with so-called “base” fertilizers before the settling of the crops and subsequently, upon sowing or transplanting, pesticides are applied to protect the growth of the crops, mainly with respect to soil phyto-phagi and pathogens.

Fertilizing formulations are available on the market both in solid form and as powders, pellets or granules with a particle diameter generally higher than 2 mm, and also in the form of liquids ready for use.

In order to obtain a particular starter effect from the fertilization of crops (direct nutrition of the seedling in its first development phases), fertilizing formulations have been recently introduced on the market, in a micro-granular form, with a diameter lower than 1.5 mm, to be applied in localization at the moment of the sowing or transplanting of crops.

Among pesticides, the soil insecticides currently on the market are usually produced by adsorbing the active ingredient on inert carriers. These products are produced in the form of micro-granules with dimensions suitable for allowing distribution on the soil with suitable devices known as micro-granulators.

On an applicative level, it has been observed that the extemporaneous mixing of micro-granulated starter fertilizing products with the above soil insecticides and more generally with pesticides on a micro-granulated inert carrier, in order to carry out a single distribution operation, is subject to various kinds of problems:
a) the risk of toxicity to the farmers, making this on-the field mixing, unless they are suitably equipped, by inhalation of the fine powders deriving from the soil insecticides, as a result of the mixing operations of the two components;
b) segregation problems between the two components, fertilizer and pesticide; segregation phenomena cause the spatial separation and stratification of these two components, particularly marked in the case of different particle-sizes, but also occurring when fractions with the same particle-size or with the equivalent presence of fractions with analogous particle-sizes are mixed; the different characteristics, in fact, of density and surface roughness of variously formulated particles, amplify segregation phenomena among the different components; there is therefore a marked heterogeneity in the composition of the mixed product which prevents the objective of obtaining an effective combined fertilization and protective treatment of the crop to be reached, as, in applications along the same row, some of the plants run the risk of receiving almost exclusively the fertilizer and others the phyto-protective product only, for example a pesticide, with a consequent lack of uniformity in development and protection and also risks of phyto-toxicity.

In addition to the problems described above, the extemporaneous mixing of a fertilizer with a phyto-protective product, for example a pesticide, and more for example a soil-insecticide or nematicide, can create problems connected with an insufficient starter fertilizing activity, when remaining within the range of the rates normally distributed by the micro-granulators present on sowing or transplanting equipment, i.e. 25-30 kg/ha, if 12-15 kg of these rates consist of the soil-insecticide or nematicide alone, formulated on an inert carrier, and the remaining 13-15 kg are represented by the micro-granular fertilizer, with a consequent under-dosage of the latter under most of the conditions, and consequently not achieving the desired starter effect. The alternative of proposing micro-granulators capable of applying greater dosages (40-45 kg/ha), allowing for the volumes of the single products, still for the sake of the example a fertilizer and a pesticide, would not only create further costs for the farmer for the purchase of new equipment, but would also weigh down the sowing machines and cause logistic problems associated with moving greater volumes of products, the necessity of storing and handling two formulates, etc.

In accordance with an aspect of the present invention, an agronomic composition is provided, preferably in a micro-granular form, according to the appended claims, comprising a fertilizer, in particular of the inorganic/mineral type, a pesticide, and one or more co-adjuvants suitable to improve the compatibility among the various components.

With the term pesticides are designated substances having a protective action on the plants against infestation in general, and includes both natural and synthetic plant protective agents. Suitable plant protective agents comprise insecticides, acaricides, fungicides, nematocides and nematostatics and mixtures thereof.

Conveniently, the presence of said co-adjuvant in the composition of the invention maintains the rapid release of the active fertilizer principles into the soil, coherently with the starter function of the compound; in addition, it preserves the agronomic efficiency of the pesticide included.

The co-formulation of an active ingredient of a pesticide with a fertilizing substance, according to the invention, takes into account the same factors which regulate the adsorption of the active ingredients on an inert carrier in addition to other specific problems:
1) adhesion of the active ingredient on the fertilizing base
2) resistance to abrasion of the active ingredient on the part of the fertilizing base
3) “life” of the active ingredient once in contact with the other components, namely the fertilizing components, and once it is applied to the soil in one formulated mixture.

As far as point 3) is concerned, the parameters relating to the pH and saline concentration, both in the matrix of the micro-granule during preservation prior to use and in the application point thereof (and consequently after use), are important, when the micro-granule dissolves in the soil due to its humidity. As a result of this, a high concentration of ions is created in the solution circulating in the soil close to the application point, which can be negative for the “life” of the pesticide and also phyto-toxic for the crops. Typically, the inorganic fertilizing component used in these formulations has a relatively rapid dissolution rate to enable it to dissolve in the solution circulating in the soil and consequently be rapidly absorbed by the roots of the plants; as the granule dissolves as a result of the humidity of the soil, this creates a considerable physico-chemical aggressiveness, due to the phenomena described above, with respect to particularly complex organic structures, such as those of the phyto-protective products in general, and of pesticides in particular, among which soil-insecticide and nematicides, possibly causing reductions in their bio-agronomic efficiency.

The addition of a phyto-protective product, namely a pesticide, to the fertilizing component can be carried out with various methods in relation to the physical state of the product (solid or liquid) and its chemical characteristics (lipophilic or hydrophilic properties, melting point for the solids); conveniently, in the case of solid active principles it is possible to englobe them in the granular matrix during the preparation of the micro-granule, for example by mixing the active ingredient with the other solid fertilizing substances, or, in the case of low-melting solid active principles, by bringing them to the liquid state and then spraying them onto the surface of the granule, according to the general techniques in the case a liquid active ingredient is adsorbed on an inert substrate; the spraying and subsequent adsorption of the phyto-protective products in general, or the pesticides in particular, in liquid phase has the advantage of avoiding subjecting the pesticide itself to the relatively high granulation temperatures for a prolonged period of time, with the risk of its degradation and necessity of formulation in a closed environment, to avoid environmental dispersion.

In according to an embodiment of the invention a useful co-adjuvant, in particular for the addition to phyto-protective products, and particularly to pesticides, in solid form comprises natural or synthetic waxes, alone or mixed with esters of fatty acids, conveniently useful for carrying out the following functions:
a) acting as a solvent in which the phyto-protective product in solid form can be dispersed to protect itself with respect to the fertilizing base, as the above mix is sprayed onto the external surface of the micro-granules in the fluid state and at a temperature of about 50° C.; the waxy component, when it subsequently solidifies, also contributes to reducing the absorption of humidity on the part of the active ingredients of the composition (hygroscopicity) before application on site, thus reducing the risk of a partial deactivation of the plant protection agents, among which pesticides.
b) improving the adhesion of the plant protection agent or pesticide to the micro-granules, and their resistance to abrasion (thus reducing dustiness), the flow and resistance to clotting of the compound.

It has been found that waxes, which are particularly suitable for fulfilling these functions, are natural carnauba and candelilla waxes; it is also possible to use beeswax, esparto wax, sugarcane wax, ozokerite, ceresin, brought to the molten state and optionally mixed with the esters of fatty acids, among which methyl esters of fatty acids are preferred. The percentage of the presence of waxes in the final micro-granule varies up to a maximum of 1% by weight. The percentage of the phyto-protective product, in particular the pesticide, varies in relation to the effective dose of the active ingredient itself.

The role of esters of fatty acids is to lower the melting point of natural waxes (81-86° C. and 68.5-72° C. respectively for carnauba and candelilla wax) to 50° C. so that the incorporation of the phyto-protective product, and in particular a pesticide, in the mix takes place under lower risk conditions for its degradation.

In accordance to another embodiment of the invention the phyto-protective product, in particular a pesticide, in liquid form and the added co-adjuvant is selected in order to protect the former from the chemical aggressiveness of the fertilizing components used. Specifically when the fertilizing component is of mineral origin, the micro-encapsulation of the phyto-protective product, and in particular of the pesticide, has proved to be particularly effective to protect the stability of the formulation, by using, for example, the interfacial polymerization technique or the separation technique in aqueous phase for lipophilic active principles or the separation technique in organic phase for hydrophilic active principles; in the former case, a coating based on poly-ureas has proved to be particularly suitable; the capsules obtained are suspended in aqueous phase and subsequently sprayed on the fertilizing micro-granule.

In particular, when the fertilizer base creates extreme conditions of pH and high free acidity of the compound specific co-adjuvant substances are added, to act as stabilizing agents of the phytoprotective products and regulators of the pH and salinity of the resulting composition. In particular, suitable co-adjuvants are selected from the group a)-f) comprising: a) hydroxyanisolbutylate (BHA), hydroxytoluenebutylate (BHT), b) vegetable epoxylated oils, c) esters of epoxylated fatty acids, d) glycols, preferably an alkylene glycol where the alkylene is of 2 to 6 C atoms, more preferably diethylene glycol, dipropylene glycol and e) ethers of C₂-C₆ alkylene glycols preferably, ethylene, diethylene, propylene, dipropylene glycol and f) mixtures thereof.

The co-adjuvants used within the scope of the invention can be conveniently added in quantities varying up to 60% by weight of the micro-granulated formulate before the phyto-protective agent, in particular a crop pesticide, is added.

It has also been unexpectedly found that the combination of a phyto-protective product with a fertilizer, for example such as those described in the Italian patent 1,301,515, with a co-adjuvant of the invention has also proved to be significantly more efficient from an agronomic point of view both with respect to nutrition, and also for the protection of the crops in their first post-sowing, or post-transplanting, development phases.

With respect to on site application, it has been found, in fact, that by distributing onto the soil, the compositions formulated according to the present invention, evident agronomic advantages can be obtained, such as greater efficacy of the pesticide component and yield increases at the end of the cycle with respect to the applications, with the same titer of formulations of the same phyto-protective products, in particular pesticides, on an inert base;
of physical mixtures between the same products on an inert base with micro-granular fertilizers;
of formulations of the same products on the same fertilizing base without the above co-adjuvants.

The greater efficiency of the phyto-protective activity of the formulations of the present invention has unexpectedly demonstrated the possibility of distributing, per surface unit/land volume, lower dosages of phyto-protective products, and in particular of pesticides, (within a reduction range varying from 10 to 20%) with the same effect, with respect to the dosages necessary when the same phyto-protective product, and in particular a pesticide, is formulated without the above-mentioned co-adjuvants. The greater efficiency of the phyto-protective product plus fertilizer compositions of the present invention with respect to the same phyto-protective active ingredient micro-granulated on an inert carrier, or however without the above-mentioned co-adjuvants, can be observed above all in the case of crop pesticides having a systemic activity: the nutritive fraction stimulates the precocious development of an extremely active root system for absorption; the greater development of the root system of the young seedling (due to the starter effect) allows a more rapid absorption of the pesticide having a systemic activity, which in this way immediately exerts the defense action and at the same time remains for a shorter period in the soil environment, with evidently lower risk of dispersion in the water and in the aerial phases. This aspect consequently also improves the ecological efficiency of the pesticide. A further aspect, which contributes to even further improving the efficiency of the pesticide, is specifically represented by the fact that the micro-granulated fertilizing components containing phyto-protective products, in particular pesticides, object of the invention, are distributed at a dosage, with respect to the surface unit, which is typical of the micro-granulated fertilizers. This dosage is about double than that used when the pesticide, micro-granulated on an inert carrier, is administered alone. This ensures that over double the number of particles containing the pesticide is distributed into the soil, with a considerable improvement in the distribution uniformity, along the row, of the innovative formulates. For example, for a crop such as sugar beet, sown in rows at a distance of 45 cm, the length of the rows of a crop present on 1 hectare is equal to 22,222 m (10000 m²/0.45 m). This means that for each linear metre, 0.54 grams of inert micro-granulated formulate, containing the pesticide alone, are applied (recommended dose: 12 kg/Ha: 12,000 grams/22,222 m), against 1.14 grams of the fertilizing micro-granulated formulate with the pesticide (recommended dose: 25 kg/Ha). As, on an average, 1 kg of micro-granulated formulate, regardless of the composition, contains about 1 million micro-granules, in both cases (0.54 and 1.14 grams/linear metre), about 500 against about 1,100 micro-granules, respectively, are distributed per linear metre: in the second condition, the probability of a rapid interception of the pesticide by the roots of the treated crop, obviously increases, thus obtaining a more complete and uniform “spatial” protection along the row.

The reduction in dosage of the phyto-protective product, in particular a pesticide in the composition, particularly significant for those products with a systemic activity, not only produces economic advantages, but also has considerable benefits from the point of view of the environmental impact and a reduced toxicity per weight unit of the compositions thus formulated, which reduces risks of pollution due to accidental dispersion in the environment and direct toxicity to the farmers using the compositions of the invention.

The compositions in micro-granular form of the invention are applied to the soil in varying quantities according to the type of phyto-protective product, in particular pesticide, crop sowing or transplanting density per hectare, and infestation conditions of pathogens and phyto-phagi to be controlled.

According to a preferred embodiment, the composition of the invention is provided in micro-granular form, in which the micro-granules have a diameter ranging from 0.1 to 2 mm, preferably from 0.1 to 1.5 mm, and more preferably with at least 90% of these having a diameter ranging from 0.1 to 0.9 mm, combining fertilizers and phyto-protective products, in particular pesticide and selected co-adjuvants.

In accordance to an embodiment the composition of the invention is provided in micro-granular form having a particle diameter distribution of
0.1-0.5 mm: about 5-7% (w/w),
0.5-0.9 mm: about 90-92% (w/w)
1.0-1.5 mm: about 1-5%(w/w).

In particular, the micro-granules of the present composition have an average particle size of 0.70 mm. Reference is also made to the CIPAC Handbook Volume F on pesticides dated 1995.

In accordance to an aspect, the following substances can be conveniently incorporated in the composition of the invention:
a) a fertilizing substance based on nitrogen, phosphorous, potassium, sulfur, calcium, magnesium, micro-elements such as Zn, Fe, Mn, B, Mo, Cu, Co, Se and their mixtures, or substances which stimulate the germination process such as vegetable or animal extracts;
b) a phyto-protective product, in particular a pesticide, of synthetic origin advantageously selected from insecticides, acaricides, fungicides, nematocides and nematostatics or a natural phyto-protective product, in particular a pesticide, having at least one from the insecticidal, acaricidal, fungicidal, nematocidal and nematostatic activities and or having an activity against the attack of weeds, also parasites, bacteria, viruses and other micro-organisms, and mixtures thereof;
c) a co-adjuvants conveniently selected from:
c.1) natural and synthetic waxes alone or mixed with esters of fatty acids, among which methyl esters are preferred when said plant protection products are in solid form;
a c.2) stabilizers (antioxidants) of the phyto-protective active ingredients such as hydroxyanisolbutylate (BHA), hydroxytoluenebutylate (BHT), vegetable epoxylated oils and esters of epoxylated fatty acids, a glycol, preferably an alkylene glycol where the alkylene is of 2 to 6 C atoms, more preferably diethylene glycol, dipropylene glycol and ethers of C₂-C₆ alkylene glycols preferably, ethers of ethylene, diethylene, propylene, dipropylene glycol when the phyto-protective product, in particular pesticide, is in liquid form;
c.3) a film encapsulating said product;
c.4)mixtures of c.1 to c.3.

The compositions, object of the invention, can be conveniently formulated according to combinations comprising one or more of the products of each single groups of compounds: a+b+c, wherein c is selected from c.1, c.2, c3 or mixtures thereof.

Typically, The compounds, objects of the invention, can be further combined with additive substances such as: silica, volcanic sands, pozzolans, zeolites, sulfates and carbonates (for example calcium and magnesium carbonates), chalk; leonardite, humic substances, humates and humic extracts; lignin-sulfonates; starches, also modified; cellulose, also modified; natural vegetable extracts and in particular natural and synthetic tannins.

According to an embodiment, the fertilizers used within the scope of the invention comprise: nitrogen-based mineral compounds, so-called simple nitrogenous fertilizers, such as calcium, ammonium, potassium, magnesium and sodium nitrates, ammonium sulfate, ammonium sulfo-nitrate; compounds based on synthesis organic nitrogen, such as urea and its condensates with aldehydes, oxamide, calciumcyanamide, and organic nitrogen of a natural origin, such as dried blood, tankage or chrysalides, hydrolyzed animal epithelium, crustacea, arachnida and insect chitin, chitosan, bird feathers, cornunghia, casein and its derivatives, burlande.

Suitable fertilizers also comprise substances containing phosphoric anhydride, such as ammonium or potassium phosphates and polyphosphates, urea-phosphoric acid addition compounds, superphosphates, natural phosphorites, calcium and aluminum phosphate, thermal phosphates or basic slag, potassium phosphite and also phospho-nitrogenated compounds of a natural organic origin such as fish meal, bone meal, dried chicken manure.

Suitable potassium-based compounds can comprise potassium salts such as potassium chloride, sulfate, phosphate, potassium sulfate with magnesium, raw potassium salts, also enriched, potassium carbonate and bicarbonate.

The micro-granular of the invention can conveniently comprise: secondary elements, such as calcium, magnesium, in the form of oxides, carbonates, sulfates, chlorides, nitrates and phosphates; sulfur, such as elemental sulfur combined in the form of salts; micro-elements such as oxides, salts, chelates and complexes of boron, cobalt, copper, iron, manganese, molybdenum, selenium, zinc and their mixtures.

All the fertilizing compounds described above can be present individually or mixed with each other.

Within the category of the phyto-protective products included in the scope of the invention, crop pesticides can be used, selected from carbamates, such as benfuracarb, carbofuran, carbosulfan, oxamyl, furathiocarb, aldicarb and propamocarb; neonicotinoids, such as imidacloprid, acetamiprid, chlothianidin (TI 435), thiacloprid, dinotefuran (MTI 446), thiametoxam; phosphoric esters, such as: diazinone, chlorpyrifos, phenamiphos, ethoprophos, cadusaphos, fosthiazate, chlormephos; pyrethroids, such as tefluthrin; phenylpyrazoles, such as fipronil; oxathines such as carboxyin; triazoles, among which tetraconazole, simeconazole, myclobutanil and triticoanzole; phospho-organic-thiophosphates such as tolclofos-methyl; nitrogen-organics such as phenyl-urea: pencycuron and acetamides: cimoxanil; benzimidazoles such as carbendazim; thiophanates such as thiophanate-methyl; isophthalonitriles such as chlorotalonil; phenylamides, for example metalaxyl, benalaxyl; phenylpyrroles, such as fludioxonyl; aluminum fosetyl and their mixtures.

Phyto-protective substances can also be used, against the attack of weeds and also parasites, bacteria, viruses and other micro-organisms; natural biological compounds, such as animal and vegetable extracts, among which essential oils, garlic extracts, nettle extracts, macro-algae extracts, and natural plant protection agents such as pyrethrum, azadiractine, rotenone, nicotine extracts and their mixtures.

In particular, it has been found that selected active ingredients belonging to the group of insecticides, nematocides/nematostatics and fungicides can be formulated with the above techniques obtaining particularly effective compositions from an agronomic point of view which can cause a reduction in the dosage of active ingredient per hectare with respect to formulations on a simple inert carrier.

In accordance with an embodiment, the above active ingredients are subdivided as follows:
Insecticides: carbamates such as carbofuran, benfuracarb, carbosulfan and oxamyl; neonicotinoids such as imidacloprid and acetamiprid; phenylpyrazoles such as fipronil; phosphoric esters such as chlormephos;
Nematocides and nematostatics such as phosphoric esters, for example cadusaphos and fosthiazate, etoprophos; carbamates such as aldicarb;
Fungicides: carbamates such as propamocarb; phenylamides such as benalaxyl and its isomer, guanidines such as dodine; phospho-organics such as Fosetyl aluminum; triazoles such as tetraconazole, triticonazole, simeconazole, myclobutanil; thiophanates, such as thiophanate-methyl; isophthalonitriles such as chlorotalonil;
phyto-protective substances against the attack of: weeds and also parasites, bacteria, viruses and other micro-organisms;
natural biological compounds such as essential oils, garlic extracts, nettle extracts, macro-algae extracts, and natural plant protection agents such as pyrethrum, azadiractine, rotenone, nicotine extracts.

The following examples are provided for illustrative purposes only and should in no way be considered as limiting the protection scope of the present invention, which is defined by the enclosed claims:

### EXAMPLE 1

First Phase of the Preparation

Mono ammonium phosphate is ground with a stepped mill until a particle size ranging from 0.2-0.4 mm, is obtained. The ground mono ammonium phosphate, chalk, soluble humates and calcium lignin-sulfonate, are charged into a mixer. The mixture is accurately homogenized and subsequently transferred to a laboratory granulator (Eirich mod. K202) where water spraying and granulation are effected (tank rate 300 rpm, blade rate 2000 rpm). The granulated product is then dried on a fluid bed at 80° C. for 10 minutes and sieved to obtain a granular composition ranging from 0.5-1 mm. Any possible granules with lower or higher dimensions are recycled in a subsequent charge having the same composition

Granular composition

| | |
|---|---|
| Mono Ammonium Phosphate | 74% |
| Calcium sulfate | 21.00% |
| Soluble humates | 1% |
| Calcium Lignin-sulfonate | 4.00% |
| Granulation water | 15.00% |
| Residual water after drying | 1% |

Second Phase

The granular composition is charged into a concrete mixer and sprayed with a Mixture (*) of Carnauba Wax or Candelilla Wax, Carbofuran and Biodiesel previously prepared as follows:

| | |
|---|---|
| Biodiesel | 42.86% |
| Carnauba or Candelilla wax | 4.76% |
| Technical Carbofuran | 52.38% |

(Biodiesel: Mixture of Methyl Esters of Fatty Acids)

The above mixture is added to the micro-granular composition obtained in the first phase, as follows:

| | |
|---|---|
| Granular composition 0.5-1 mm | 95.8% |
| Mixture (*) | 4.2% |

It is left to rotate until the granule has completely dried.

### EXAMPLE 2

The same procedure is adopted as in Example 1, using technical Fosetyl Al instead of technical Carbofuran.

### EXAMPLE 3

First Phase

Mono ammonium phosphate is ground with a stepped mill until a particle size ranging from 0.2-0.4 mm, is obtained. The ground mono ammonium phosphate, Calcium Sulfate (chalk), soluble humates and calcium ligninsulfonate, are charged into a mixer. The mixture is accurately homogenized and is subsequently transferred to a laboratory granulator (Eirich mod. K202) where water spraying and granulation are effected (tank rate 300 rpm, blade rate 2000 rpm). The granulated product is then dried on a fluid bed at 80° C. for 10 minutes and sieved to obtain a granular composition ranging from 0.5-1 mm.

Any possible granules with lower or higher dimensions are recycled in a subsequent charge having the same composition

Composition of the granular part

| | |
|---|---|
| Mono Ammonium Phosphate | 63.94% |
| Calcium Sulfate | 32.00% |
| Soluble humates | 0.06% |
| Calcium Lignin-sulfonate | 4.00% |
| Granulation water | 15.00% |
| Residual water after drying | 0.5% |

Second Phase

The granular composition is charged into a concrete mixer and sprayed with a pre-mixture of Benfuracarb thus composed:

| | |
|---|---|
| Technical Benfuracarb 92% | 66% |
| Diethylene glycol | 22% |
| Ethylene diglycol | 12% |
| End-product | |
| Granular composition 0.5-1 mm | 96.7% |
| Benfuracarb pre-mixture | 3.3% |

The mixture is left to rotate until the granule has completely dried.

### EXAMPLE 4

Preparation of a Composition

60 kg of mono-ammonium phosphate in powder form, 33 kg of degreased dried blood, 1 kg of soluble humates, 4 kg of calcium lignin-sulfonate, are mixed with each other in a powder mixer. After mixing, the whole mixture is charged into a rotating granulator in which a certain quantity of water is sprayed, thus obtaining, after drying and sieving, a micro-granular fertilizer having granules with dimensions ranging from 0.5 to 1 mm. Any possible granules with lower or higher dimensions are recycled in a subsequent charge having the same composition. These granules are used as substrate on which a mixture of technical benfuracarb dispersed in epoxilade soybean oil B, is sprayed, thus obtaining in the end-product a concentration of benfuracarb equal to 2%. The same formulation can be used in a combination with the plant protection agents carbosulfan and furathiocarb, which are used at the same concentration as benfuracarb.

### EXAMPLE 5

Preparation

71.5 kg of mono-ammonium phosphate in powder form, 10 kg of chalk, 9.5 kg of pozzolan, 3 kg of zinc oxide, 1 kg of soluble humates, 4 kg of calcium lignin-sulfonate, are mixed with each other in a powder mixer. After mixing, the whole mixture is charged into a rotating granulator in which a certain quantity of water is sprayed, thus obtaining, after drying and sieving, a micro-granular fertilizer having granules with dimensions ranging from 0.5 to 1 mm. Any possible granules with lower or higher dimensions are recycled in a subsequent charge having the same composition. These granules are used as substrate on which a mixture of technical fipronil dispersed in wax is sprayed, thus obtaining in the end-product a concentration of fipronil at 0.5%.

### EXAMPLE 6

Preparation

70 kg of mono-ammonium phosphate in powder form, 10 kg of chalk, 10 kg of starch, 5 kg of manganese oxide, 1 kg of natural tannin extracts, 3.75 kg of calcium ligninsulfonate, are mixed with each other in a powder mixer. After mixing, the whole mixture is charged into a rotating granulator in which a certain quantity of water is sprayed, thus obtaining, after drying and sieving, a micro-granular fertilizer having granules with dimensions ranging from 0.5 to 1 mm. Any possible granules with lower or higher dimensions are recycled in a subsequent charge having the same composition. These granules are used as substrate on which a mixture of imidacloprid dispersed in biodiesel and waxes is sprayed, thus obtaining in the end-product a concentration of imidacloprid equal to 0.25%.

The same formulation can be used in a combination with the active ingredient tefluthrin which is used at the same concentration as imidacloprid.

### EXAMPLE 7

10.7 kg of mono-ammonium phosphate in powder form, 21 kg of degreased, dried blood, 19 kg of iron sulfate, 20 kg of potassium sulfate, 10 kg of magnesium sulfate, 10 kg of calcium sulfate, 1.5 kg of soluble humates, 5 kg of calcium lignin-sulfonate, are mixed with each other in a powder mixer. After mixing, the whole mixture is charged into a rotating granulator in which a certain quantity of water is sprayed, thus obtaining, after drying and sieving, a micro-granular fertilizer having granules with dimensions ranging from 0.5 to 1 mm. Any possible granules with lower or higher dimensions are recycled in a subsequent charge having the same composition. These granules are used as substrate on which a mixture of technical fosethyl aluminum dispersed in biodiesel and waxes is sprayed, thus obtaining in the end-product a concentration of fosethyl aluminum of 2.8%.

The same formulation can be used in a combination with potassium phosphite which is used at the same concentration as fosethyl aluminum.

### EXAMPLE N.8

### Referred to Preparation Example N. 4

Crop: Corn (Maize)

Pest Target to Control: Wire—Worms: Agriotes ustulatus Schaller

Treatments:

Microgranulated Soil-insecticide Benfuracarb formulated on inert substances vs. the same active ingredient formulated on a microgranulated fertilizer according to the invention.

Materials:

Pots: plastic pots (cm 14 diameter and 1,4 liters volume) with bottom holes covered by unbleached linen cloth to avoid insects escape and to limit water leaching: two corn seeds sowed in each plot.

Soil characteristics: sandy, poor of nutrients, constantly irrigated at maximum water-holding capacity (2-3 mm of water each 2 days).

Methods

Scheme: plots were divided into randomized blocks (5 repetitions per treatment) and put in half-light conditions. Within 24 hours from pots preparation, 20 larvae of Agriotes ustulatus Schaller were put in each pot.

Observations

Number of emerged plants (healthy and with symptoms of insect damages). After 30 days from sowing time, seeds and plants have been removed to count numbers of attacks by insect larvae.

Evaluation of larvae status: larvae were divided into two groups: alive larvae and dead/dying larvae

Number of healthy and damaged plants per plot; a normal development means no symptoms of damage and development superior than the average development of plots where larvae were not put.

Plants height at the end of the trial

Number of total larvae attacks (to seeds+to seedlings)

Final fresh weight and dry weight per plant

Treatments

| | | |
|---|---|---|
| T. 1 | Untreated seeds + wire-worms larvae | |
| T. 2 | DAP (diammonium phosphate) dosage: 100 | Active ingredient |
| | kg/ha localized 5 cm below the seed + | dosage: |
| | Benfuracarb (4.7%)on inert substances | 564 g/ha |
| | dosage: 12 kg/ha at direct contact with | |
| | the seed | |
| T. 3* | Physical blend between microgranular fertilizer | Active ingredient |
| | base as such; dosage: 28 kg/ha + Benfuracarb | dosage: |
| | (4.7%)on inert substances | 564 g/ha |
| | dosage: 12 kg/ha at direct contact with | |
| | the seed | |
| T. 4 | Benfuracarb (2%) coformulated on | Active ingredient |
| | microgranular fertilizer base; dosage 28 kg/ha | dosage: |
| | at direct contact with the seed | 564 g/ha |
| T. 5 | Benfuracarb (2%) coformulated on | Active |
| | microgranular fertilizer base; dosage 20 kg/ha | ingredient |
| | at direct contact with the seed | dosage: |
| | | 400 g/ha |

*Physical blend prepared at the moment of application; total amount: 40 kg/ha

| | | | Total | N. of | Normally | | Final | Dry |
|---|---|---|---|---|---|---|---|---|
| | Dead/dying | Alive | damages | Emerged | developed | Damaged | height | weight |
| Treatments | Larvae | Larvae | p.plant | plants | plants | plants | cm | g/plant |
| 1 | 3.8 | 16.2 | 6.6 | 1.2 | 0 | 2 | 6.4 | 0.022 |
| 2 | 10 | 10 | 3.4 | 1.4 | 1 | 1 | 9.8 | 0.032 |
| 3 | 9.6 | 10.4 | 4.3 | 1 | 0.6 | 1.4 | 5.75 | 0.042 |
| 4 | 8.8 | 11.2 | 4.3 | 1.6 | 1.2 | 0.8 | 9.25 | 0.037 |
| 5 | 8.2 | 11.8 | 5.1 | 1.8 | 1.4 | 0.6 | 14.15 | 0.043 |

The microgranular fertilizer base is composed according to preparation example n. 4.

It may be observed that the use of Benfuracarb (2%) coformulated on microgranular fertilizer base (t.4), especially at the lower rate (t.5: 30% reduction of active ingredient/ha) is able to increase plants emergence, the number of normally developed plants (able to overpass the stress of larvae damages), the growth indices (plant heiight and weight);

In comparison to t. 2, where a traditional fertilizer (diammonium phosphate—granule size bigger than 2 mm) is applied providing 18 kg/ha of nitrogen and 46 kg/ha of P2O5 (phosphorous pentoxide), treatments 4 and 5 gave respectively 3 kg/ha of nitrogen and 8,4 of phosphorous pentoxide and 2,2 kg/ha of nitrogen and 6 of phosphorous pentoxide obtaining even better results in terms of plant development (increase of efficiency). The good performance of t. 4 and 5 vs. t.3 (physical blend) shows the importance of distribution uniformity (allowed only by a compound product and not by a blend; of course under field conditions this difference will be further increased: see description at page 4 and 5).

### EXAMPLE N.9

### Referred to Preparation Example N.4

Similar results of the application example n. 8 were obtained with a formulation of Carbosulfan as active ingredient (preparation example n.4) and Fipronil as active ingredient (preparation example n. 5).

### EXAMPLE N.10

### Referred to Preparation Example N. 4) Crop: Tabacco Cultivar: Virginia Bright McNair 944 (transplanted)

Pest Target to Control: Bean Aphid (Aphis fabae)

TREATMENTS: Microgranulated Soil-insecticide Benfuracarb formulated on inert substances vs. the same active ingredient formulated on a microgranulated fertilizer according to the invention.

Materials and Methods

One week after products application, ten insects were put on each plant (3-4 female and 6-7 larvae) and the day after the successfull application was detected, according to the presence of a large amount of newborn insects: as many as 15 per plant).

Treatments

| | |
|---|---|
| T. 1 | Check non treated (no fertilizer and no insecticide application) |
| | with the presence of insects |
| T. 2 | DAP (diammonium phosphate) dosage: 150 kg/ha localized 5 cm |
| | below the seedling roots + Benfuracarb (4.7%)on inert substances |
| | dosage: 12 kg/ha at direct contact with the seedling roots with |
| | presence of insects |
| T. 3 | Benfuracarb (2%) coformulated on microgranular fertilizer base; |
| | dosage 28 kg/ha at direct contact with the seedling roots |
| | (same quantity of active ingredient per ha of t. 2) |
| | with presence of insects |
| T. 4 | Benfuracarb (2%) coformulated on microgranular fertilizer base; |
| | dosage 20 kg/ha at direct contact with the seedling roots (30% |
| | reduction of active ingredient per ha) with presence of insects |

Results

The number of insects detected in the various treatments at two different stages is statistically different (0.05%) showing a different uptake of the systemic active ingredient in relation to the different formulations; at 5 and 12 days after the insect launch, treatments 3 and 4 had a lower number of insects than treatments 1 and 2, evidence of a faster uptake by the roots of the active ingredient and early presence of the a.i. itself in the plant tissues where the aphids suck the sap. It may be noted that the use of a reduced rate of Benfuracarb coformulated on microgranulated fertilizer base (according to preparation example n. 4) is as effective as the full dosage.

| | N. of aphids 5 days | N. of afids 12 |
|---|---|---|
| Treatments | after treatment | days after treatment |
| 1 | 28 a | 27 a |
| 2 | 24 a | 30 a |
| 3 | 1 b | 9 b |
| 4 | 3 b | 8 b |

### APPLICATION EXAMPLE N.11

### Referred to Preparation Example N. 4) Crop: Tobacco Cultivar: Virginia Bright cult. K326 (transplanted)

Pest Target to Control: Tobacco Flea (Epithrix hirtipennis)

TREATMENTS: Microgranulated Soil-insecticide Benfuracarb formulated on inert substances vs. the same active ingredient formulated on a microgranulated fertilizer according to the invention.

Materials and Methods

The trial has been carried out at Fattoria Autonoma Tabacchi of Città di Castello (Perugia) Italy, under the supervision of University of Pisa (Department of Agronomy). Field scheme: randomized blocks with four repetitions

Treatments:

| Treatments number | Treatments description |
|---|---|
| 1 | Check |
| 2 | Benfuracarb (4.7%)on inert |
| | substances dosage: 12 kg/ha at |
| | direct contact with the seedling |
| | roots |
| | (564 g/ha a.i.). |
| 3 | Microgranular fertilizer |
| | Base |
| | Dosage: 28 kg/ha |
| 4 | Benfuracarb (2%) coformulated |
| | on microgranular fertilizer |
| | base; dosage 28 kg/ha at direct |
| | contact with the seedling |
| | roots (same quantity of active |
| | ingredient per ha of t. 2: 564 g./ha a.i.) |

| | | N. of | N. of | N. of | Epithrix | Epithrix |
|---|---|---|---|---|---|---|
| | Days to | leaves at | leaves | leaves at | damages | damages |
| | overpass | 20 days | at 35 | 50 days | at 20 | at 50 |
| | transplanting | after | days after | after | days from | days from |
| Treatments | crisis | transplanting | transplanting | transplanting | transplanting | transplanting |
| 1 | 12 | 2.8 | 4.5 | 5.3 | 67.1 | 85.4 |
| 2 | 12 | 2.1 | 5.2 | 7.9 | 18.2 | 33.7 |
| 3 | 8 | 3.3 | 6.0 | 8.5 | 45.6 | 51.4 |
| 4 | 10 | 3.5 | 7.2 | 12.6 | 7.8 | 12.6 |

It may be noted that the use of the compound of treatment 4 (prepared according to preparation example 4, where dry degreased blood and soluble humates had been replaced by MAP: monoammonium phosphate, to give a totally mineral/inorganic formulation) gives better results than treatment 2 in terms of less damages by insect attacks. Treatment 4 is also more effective than treatment 3 (only fertilizer base) referring to the development parameters, evidence of a sinergic activity with the active ingredient.

1. A composition for agricultural use in microgranular form having micro-granules with a diameter ranging from 0.1 to 2 mm comprising a mineral/inorganic fertilizer, a phyto-protective product and a co-adjuvant characterised by the fact that said co-adjuvant is selected from
i) a wax when said phyto-protective product is in solid form;
ii) a stabilizer when said phyto-protective product is in liquid form, said stabilizer being selected from the group comprising hydroxyanisolbutylate (BHA), hydroxytoluenebutylate (BHT), vegetable epoxylated oils and esters of epoxylated fatty acid, a glycol, preferably diethylene glycol, dipropylene glycol, a C₂-C₆ alkylene ether preferably ether of ethylene, diethylene, propylene, dipropylene glycol and mixtures thereof.
iii) mixtures of i) and ii)

2. The composition according to claim 1, where said plant-protective product is a crop pesticide.

3. The composition according to claims 1-2, characterized in that said inorganic fertilizers comprise one or more elements selected from nitrogen, phosphorous, potassium, calcium, magnesium, sulfur, boron, cobalt, copper, iron, manganese, molybdenum, selenium, zinc and their mixtures.

4. The composition according to anyone of claims 1-3, characterized in that it additionally comprises one or more natural organic fertilizers.

5. The composition according to one or more of claims 1-4, characterized in that it additionally comprises one or more fertilizers with synthesis nitrogen obtained from aldehydes condensed with urea.

6. The composition according to one or more of the previous claims 2-5, characterized in that said crop pesticides are selected from insecticides, acaricides, fungicides, nematocides and nematostatics and their mixtures.

7. The composition according to one or more of the previous claim 2-6, wherein said pesticides are animal or vegetable extracts, selected from essential oils, garlic extracts, nettle extracts, macro-algae extracts, pyrethrum, azadiractine, rotenone, nicotine extracts, chitosan and mixtures thereof.

8. The composition according to one or more of the previous claims 1-7, characterized in that the diameter of the micro-granules ranges from 0.1 to 1.5 mm.

9. The composition according to one or more of the previous claims 1-8, characterized in that at least 90% of the micro-granules has a diameter ranging from 0.1 to 0.9 mm.

10. The composition according to claim 1, wherein said waxes are selected from carnauba and candelilla waxes.

11. The composition according to claim 1, wherein said waxes incorporates esters of fatty acids.

12. The composition according to one or more of the previous claims 1-11, characterized in that said phyto-protetive products are micro-encapsulated.

13. The composition according to claim 1, wherein the phyto-protective product is encapsuled in a film based on polyureas.

14. The composition according to one or more of the previous claims 1-13, characterized in that said composition further comprises one or more substances selected from: silica, volcanic sands, pozzolans, zeolites, sulfates and carbonates, chalk, leonardite, humic substances, humates and humic extracts; lignin-sulfonates, starches, modified and non-modified; cellulose, modified and non-modified, natural vegetable extracts, natural or synthetic tannins and mixtures thereof.

15. The composition according to claim 6, characterized in that said insecticides are selected from carbamates, neonicotinoids, phenylpyrazoles, phosphoric esters and their mixtures.

16. The composition according to claim 15, characterized in that said carbamates comprise carbofuran, benfuracarb, carbosulfan, oxamyl, aldicarb and mixtures thereof.

17. The composition according to claim 15, characterized in that said neonicotinoids comprise imidacloprid, acetamiprid and their mixtures.

18. The composition according to claim 15, characterized in that said phenylpyrazole is fipronil.

19. The composition according to claim 15, characterized in that said phosphoric ester is chlormephos.

20 The composition according to claim 6, characterized in that said fungicides comprise phenylamides, triazoles, thiophanates, isophthalonitriles, fosetyl aluminum and their mixtures.

21. The composition according to claim 20, characterized in that said phenylamides comprise benalaxyl or its raceme.

22. The composition according to claim 20, characterized in that said triazoles comprise tetraconazole, triticonazole, myclobutanil and their mixtures.

23. The composition according to claim 20, characterized in that said thiophanate is thiophanate-methyl.

24. The composition according to claim 20, characterized in that said isophthalonitrile is chlorotalonil.

25. The composition according to claim 6, wherein said nematocides or nematostatics comprise phosphoric esters.

26. The composition according to claim 25, characterized in that said phosphoric esters comprise cadusaphos, fostiazate, etoprophos and their mixtures.

27. The composition according to one or more of claims 1 to 26, characterized in that it further comprises potassium phosphite.

28. A method for the combined fertilizing and phyto-protective treatment of crops, comprising the application to the soil of an effective quantity of a composition according to one or more of claims 1-27.

29. The method according to claim 28, characterized in that said application takes place by localization at the seed, seedling and plant.

30. The method according to claim 28, characterized in that said application takes place contemporaneously with the sowing and transplanting of crops.
